(19) United States
(12) Patent Application Publication
(10) Pub. No.: US 2024/0121622 A1
(43) Pub. Date: Apr. 11, 2024

(54) SYSTEM AND METHOD FOR AERIAL-ASSISTED FEDERATED LEARNING

(71) Applicant: SAMSUNG ELECTRONICS CO., LTD., SUWON-SI (KR)

(72) Inventors: Tushar Vrind, Bangalore (IN); Debabrata Das, Bangalore (IN)

(21) Appl. No.: 18/484,087

(22) Filed: Oct. 10, 2023

(30) Foreign Application Priority Data
Oct. 10, 2022 (IN) 202241057733

(51) Int. Cl. H04W 16/22; H04B 7/185; H04W 24/02

(52) U.S. Cl. CPC H04W 16/22; H04B 7/18504; H04W 24/02; H04W 84/06

(57) ABSTRACT

The present disclosure provides a system and a method for aerial-assisted federated learning at a Federated Learning (FL) server. The method includes receiving a plurality of parameter sets and trajectory information indicating a coverage range by the FL server from a plurality of User Equipment (UEs) and an aerial cell, respectively. Further, the FL server selects at least one UE from the plurality of UEs based on the received plurality of parameter sets and the received trajectory information. Additionally, the FL server triggers an activation of the aerial link between the aerial cell and the selected at least one UE to include the selected at least one UE to a set of federated UEs associated with the FL server.

### CROSS-REFERENCE TO RELATED APPLICATION

This application is based on and claims priority under 35 U.S.C. § 119 to Indian Patent Application No. 202241057733, filed on Oct. 10, 2022, in the Indian Intellectual Property Office, the contents of which are incorporated by reference herein in their entirety.

### TECHNICAL FIELD

The present disclosure generally relates to a field of wireless communication networks, and more specifically relates to a system and a method for aerial-assisted federated learning for enhancing efficiency in beyond 5G networks.

### BACKGROUND

The ever-increasing demand for high-speed, low-latency, and reliable wireless communication services has resulted in the evolution of communication networks beyond the 5th Generation (5G). Beyond 5G networks, i.e., 6G and future generations, aim to support an overwhelming number of connected devices with low latency and high bandwidth requirements and include applications spanning augmented reality (AR), virtual reality (VR), Internet of Things (IoT), autonomous vehicles, etc. However, the realization of the beyond 5G networks requires enhancement of network efficiency, scalability, and adaptability. Further, a concept of Federated Learning (FL) (i.e., collaborative learning) is used for managing privacy concerns associated with the beyond 5G networks. The collaborative learning is an important technique in Machine Learning (ML).

Federated learning has emerged as a promising technique for decentralized model training and optimization in wireless communication networks. It allows edge devices to collaboratively train machine learning models without sharing raw data, thereby preserving user privacy and reducing communication overhead. Additionally, aerial platforms complement ground-based infrastructure by providing aerial connectivity and data offloading. However, efficiently integrating aerial platforms into communication networks and orchestrating their actions to enhance network performance remains a challenging task. Therefore, there is a need in the art for systems and methods that can efficiently perform aerial-assisted federated learning in beyond 5G networks.

### SUMMARY

This summary is provided to introduce a selection of concepts, in a simplified format, that are further described in the detailed description of the invention. This summary is neither intended to identify key or essential inventive concepts of the invention nor is it intended for determining the scope of the invention.

The present disclosure describes systems and methods for wireless communication. One or more embodiments of the present disclosure are configured to select a user equipment for federated learning based on a terrestrial CQI and trajectory information of a plurality of user equipment. According to an embodiment, an aerial link between the selected user equipment and a set of user equipment is triggered and a federated learning process is performed using the aerial link. In some cases, the federated learning process is used for enabling a process of dual communication between the user equipment and the aerial link.

According to an embodiment, a method for aerial-assisted federated learning at a Federated Learning (FL) server is disclosed. The method includes receiving, from a plurality of User Equipment (UEs), a plurality of parameter sets, respectively. Each of the plurality of parameter sets includes a terrestrial link Channel Quality Indicator (CQI), location information, and capability information of a corresponding UE to handle Dual Communication (DC) with an aerial link. The method further includes receiving, from an aerial cell, trajectory information indicating a coverage range of the aerial cell. Further, the method includes selecting at least one UE from the plurality of UEs based on the received plurality of parameter sets and the received trajectory information. Further, the method includes triggering an activation of the aerial link between the aerial cell and the selected at least one UE to include the selected at least one UE to a set of federated UEs associated with the FL server.

Also disclosed herein is a federated learning (FL) server including one or more processors and a transceiver. The transceiver is configured to receive, from a plurality of User Equipment (UEs), a plurality of parameter sets, respectively. Each of the plurality of parameter sets includes a terrestrial link Channel Quality Indicator (CQI), location information, and capability information of a corresponding UE to handle Dual Communication (DC) with an aerial link. Further, the transceiver is configured to receive, from an aerial cell, trajectory information indicating a coverage range of the aerial cell. The one or more processors are configured to select at least one UE from the plurality of UEs based on the received plurality of parameter sets and the received trajectory information. Further, the one or more processors are configured to trigger an activation of the aerial link between the aerial cell and the selected at least one UE to include the selected at least one UE to a set of federated UEs associated with the FL server.

Also disclosed herein is a system including a plurality of User Equipment (UEs) coupled with a primary cell based on a terrestrial link. The system further includes an aerial cell and a federated learning (FL) server communicatively connected with the primary cell, the aerial cell, and the plurality of UEs. The FL server includes one or more processors and a transceiver. The transceiver is configured to receive a plurality of parameter sets, respectively, from the plurality of UEs. Each of the plurality of parameter sets includes the terrestrial link Channel Quality Indicator (CQI), location information, and capability information of a corresponding UE to handle Dual Communication (DC) with an aerial link. Further, the transceiver is configured to receive, from the aerial cell, trajectory information indicating a coverage range of the aerial cell. Additionally, the one or more processors are configured to select at least one UE from the plurality of UEs based on the received plurality of parameter sets and the received trajectory information. Further, the one or more processors are configured to trigger an activation of the aerial link between the aerial cell and the selected at least one UE to include the selected at least one UE to a set of federated UEs associated with the FL server.

Also disclosed herein is a method for aerial-assisted federated learning at a User Equipment (UE). The method includes sending, to a Federated Learning (FL) server, a plurality of parameter sets, respectively. Each of the plurality of parameter sets includes a terrestrial link Channel Quality Indicator (CQI), location information, and capability information of a corresponding UE to handle Dual Communication (DC) with an aerial link. In some cases, the FL server selects the UE for the DC with the aerial link when the terrestrial link CQI of the UE is lower than a threshold value and the capability information indicates that the UE can handle the DC with the aerial link. The method further includes receiving, a primary cell upon selection of the UE by the FL server, a cell configuration of the aerial cell for synchronization of the UE with the aerial cell for enabling the UE to handle DC with the aerial link. Further, the method includes performing an FL process using the aerial link with the FL server.

Also disclosed herein is a method for aerial-assisted federated learning comprising generating a parameter set including capability information of a User Equipment (UE) to handle Dual Communication (DC) with an aerial cell. The method further includes transmitting the parameter set to a Federated Learning (FL) server. Additionally, the method includes receiving a cell configuration for synchronization of the UE and the aerial cell based on the parameter set. Further, the method includes performing an FL process via the aerial link with the aerial cell and the FL server. Additionally, the parameter set includes a terrestrial link Channel Quality Indicator (CQI), wherein the cell configuration is received based at least in part on the terrestrial link CQI. Additionally, the performing the FL process comprises receiving a global model distribution, performing a machine learning training process based on the global model distribution and transmitting a training result report to the FL server based on the machine learning training process.

To further clarify the advantages and features of the present invention, a more particular description of the invention will be rendered by reference to specific embodiments thereof, which are illustrated in the appended drawings. It is appreciated that these drawings depict only typical embodiments of the invention and are therefore not to be considered limiting of its scope. The invention will be described and explained with additional specificity and detail in the accompanying drawings.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 illustrates an example scenario depicting the FL process, in accordance with an existing prior art;

FIG. 2 illustrates a federated learning protocol in a terrestrial wireless network, in accordance with an existing prior art;

FIG. 3A illustrates an example scenario depicting a deployment of a terrestrial network, in accordance with an existing prior art;

FIG. 3B illustrates an example scenario depicting deployment of the terrestrial network in which the Low Altitude Aerial Platforms (LAP) based aerial cell assists the terrestrial network in improving coverage, capacity, and latency, according to one or more embodiments disclosed herein;

FIG. 4 illustrates a system for aerial-assisted federated learning, according to one or more embodiments disclosed herein;

FIG. 5 illustrates a process flow for aerial-assisted federated learning, according to one or more embodiments disclosed herein;

FIG. 6 illustrates a line diagram depicting a process flow of activating Dual Communication (DC) to enable federated learning in beyond 5G Networks, according to one or more embodiments disclosed herein; and

FIG. 7 illustrates a flow diagram for aerial-assisted federated learning at a federated learning server, according to one or more embodiments disclosed herein; and

FIG. 8 illustrates a flow diagram for aerial-assisted federated learning at a user equipment (UE) among a plurality of UEs, according to one or more embodiments disclosed herein.

Further, skilled artisans will appreciate that the elements in the drawings are illustrated for simplicity and may not have necessarily been drawn to scale. For example, the flow charts illustrate a method in terms of the most prominent steps involved to help improve understanding of aspects of the present invention. Furthermore, in terms of the construction of the device, one or more components of the device may have been represented in the drawings by conventional symbols, and the drawings may show only the specific details that are pertinent to understanding the embodiments of the present invention so as not to obscure the drawings with details that will be readily apparent to those of ordinary skill in the art having the benefit of the description herein.

### DETAILED DESCRIPTION

The present disclosure describes systems and methods for wireless communication. One or more embodiments of the present disclosure are configured to select a user equipment for federated learning based on a terrestrial CQI and a trajectory information using a machine learning model. According to an embodiment, an aerial link between the selected user equipment and a set of user equipment is triggered and a federated learning process is performed using the aerial link. In some cases, the federated learning process is used for enabling a process of dual communication between the user equipment and the aerial link.

Conventional user equipment performing a federated learning (FL) process includes downloading an artificial intelligence model from a FL server followed by model training and using the updated model in a next training iteration until a maximum number of iterations is reached or a desired AI model accuracy is achieved. However, as each UE is connected to the FL server via the terrestrial wireless link, network coverage and capacity of the terrestrial wireless link are critical factors in the UE's availability and participation in the FL process. Due to limitations of fixed terrestrial infrastructure deployment, such as cell edge scenarios and sudden conglomeration of the users, terrestrial wireless networks are unable to guarantee network coverage and capacity at all times.

Additionally, existing methods for federated learning need to deal with a slew of fundamental issues, such as ML-communication co-design while taking into consideration device constraints and wireless channel characteristics. An existing solution proposes minimizing energy consumption of an FL system while simultaneously optimizing learning and communication costs. Further, another existing solution discusses the federated learning architecture and procedure for device selection and captures requirements for beyond 5G wireless networks to enable the FL process. However, each of these existing solutions lacks a wireless link to increase a number of participating devices in the FL process.

Embodiments of the present disclosure include systems and methods for wireless communication system that can increase a number of participating devices in the FL process. In some embodiments, a terrestrial network is used that performs a communication between a user equipment and a core network based on a terrestrial cell. For example, an availability of a user equipment is based on the terrestrial network. In some cases, a low-altitude aerial platform (LAP) based aerial cell is used in the terrestrial network.

According to some embodiments, an LAP based aerial cell enables an expansion of the network coverage and a capacity of the terrestrial network. In some cases, the aerial cell is placed or moved to optimize its position thereby providing connectivity to the user equipment. Thus, the user equipment can provide for dual communication with the aerial and terrestrial cells. Accordingly, by enhancing the availability, capacity, and latency of the terrestrial network using the aerial cell, user equipment with high computing and storage features can be deployed in the federated learning process. Moreover, such a system can increase the number of participating user devices in the FL process.

Embodiments of the present disclosure include an operating method of aerial-assisted federated learning at a Federated Learning (FL) server. In some cases, the FL server receives a plurality of parameter sets from a UE that includes a terrestrial link Channel Quality Indicator (CQI), location information, and capability information of a UE to handle Dual Communication (DC) with an aerial link. Additionally, the FL server receives trajectory information indicating a coverage range of an aerial cell. The FL server selects a UE based on the parameter sets and the trajectory information and triggers an activation of the aerial link between the aerial cell and the selected UE for inclusion to a set of federated UEs.

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present invention. Thus, appearances of the phrase “in an embodiment”, “in one or more embodiments”, “in another embodiment”, and similar language throughout this specification may, but do not necessarily, all refer to the same embodiment.

The terms “comprise”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components preceded by “comprises . . . a” does not, without more constraints, preclude the existence of other devices or other sub-systems or other elements or other structures or other components or additional devices or additional sub-systems or additional elements or additional structures or additional components.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of modules or engines that carry out a described function or functions. These modules or engines, which may be referred to herein as units or blocks or the like, or may include blocks or units, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware and software. The circuits may, for example, be embodied in one or more semiconductor chips, or on substrate supports such as printed circuit boards and the like. The circuits constituting a block may be implemented by dedicated hardware, by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the invention. Likewise, the blocks of the embodiments may be physically combined into more complex blocks without departing from the scope of the invention.

The accompanying drawings are used to help easily understand various technical features and it should be understood that the embodiments presented herein are not limited by the accompanying drawings. As such, the present disclosure should be construed to extend to any alterations, equivalents, and substitutes in addition to those which are particularly set out in the accompanying drawings. Although the terms first, second, etc. may be used herein to describe various elements, these elements should not be limited by these terms. These terms are generally only used to distinguish one element from another.

Embodiments of the present disclosure include a wireless communication system configured to perform aerial-assisted federated learning for increasing the number of participating devices in the federated learning process. The present disclosure is not limited to any particular wireless network and may be applied to wireless communication systems having a similar technical background or channel configuration.

Hereinafter, a wireless communication system performing a federated learning process of the embodiments of the present disclosure will be described below in detail with reference to the accompanying drawings.

An FL server performs training on decentralized data where the training data is distributed on several nodes in FL architecture for managing privacy concerns. This involves an FL process that applies a Federated Averaging (FA) algorithm, which combines local stochastic gradient descent (SGD) feedback from each of the nodes at the FL server to perform model averaging. The FL process is an enabler for solving data privacy-related issues, as there is no need to transfer the generated training data sets from each of the nodes to the FL server. In a wireless communication network, each of these nodes corresponds to a User Equipment (UE) with a neural engine, that is connected to the FL server via a terrestrial wireless link.

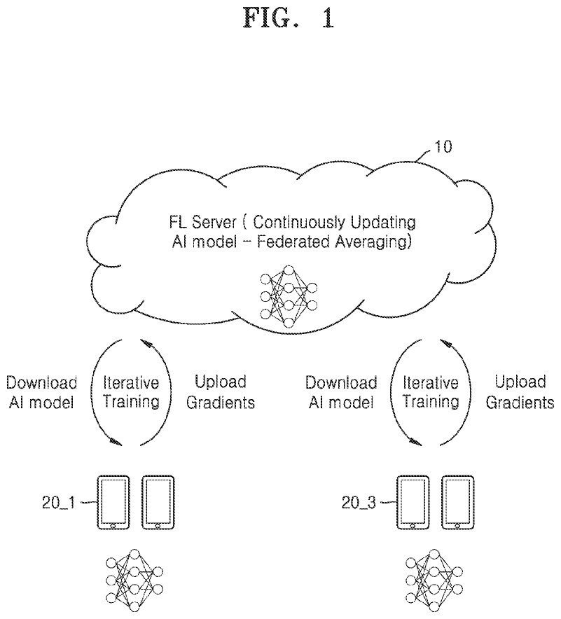

FIG. 1 illustrates an example scenario depicting the FL process, in accordance with an existing state of art. The FL server 10 includes an AI model which is trained by the UEs (20-1, 20-3) (also referred to as federated UEs). In each training iteration, the federated UEs (20-1, 20-3) are selected by the FL server 10 when the federated UEs (20-1, 20-3) download the AI model from the FL server 10 using a downlink (DL) channel of the terrestrial wireless link and train the AI model using local training data. The gradients for the AI model are then reported by the federated UEs (20-1, 20-3) to the FL server 10 via an uplink channel (UL) of the terrestrial wireless link. At the FL server 10, the gradients from all the federated UEs (20-1, 20-3) are aggregated, and the AI model is updated. Further, a federated averaging method is used by the FL process to aggregate local Stochastic Gradient Descent (SGD) feedback from each of the federated UEs (20-1, 20-3) at the FL server 10. The updated AI model is then used in the next training iteration, and the process keeps on repeating until a termination criterion is met. In a non-limiting example, the termination criteria may include reaching a maximum number of iterations or achieving a desired AI model accuracy.

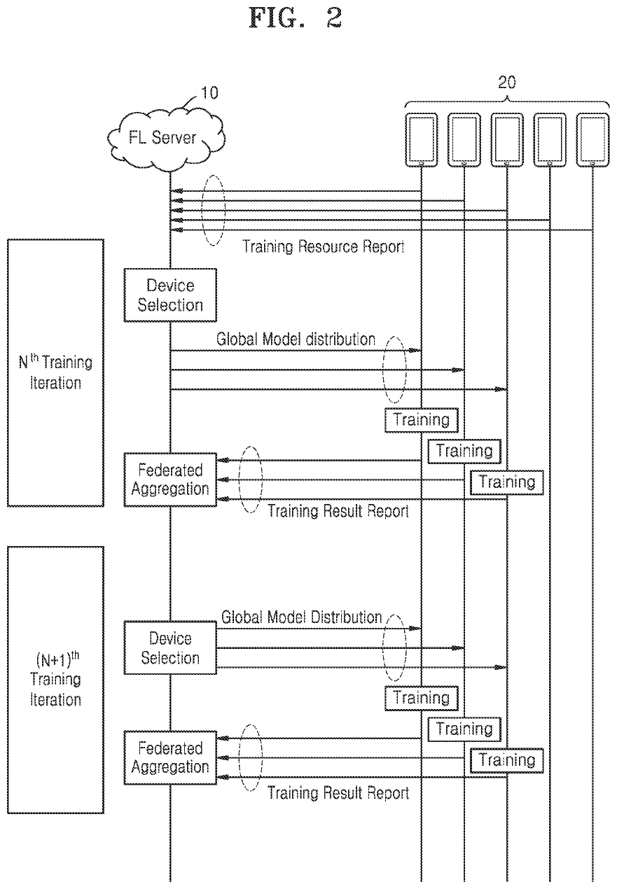

FIG. 2 illustrates a federated learning protocol in a terrestrial wireless network, in accordance with an existing state of the art. FIG. 2 illustrates two iterations, N and (N+1), depicting the FL protocol for the beyond 5G networks. Once, the FL service is enabled in the wireless network, in the Nth iteration, available UEs 20 transmit their training resource report to the FL server 10. Thereafter, the FL server 10 selects the federated UEs from the available UEs 20 based on the training resource report corresponding to each of the available UEs 20. Some of the factors in selecting the federated UEs include a computation power of the available UEs 20, the wireless channel condition associated with the available UEs 20, and the geographic location of the available UEs 20. The selected federated UEs then download the AI model, train the AI model, and send model gradients to the FL server 10. For instance, the federated UEs send the model gradients as a training result report to the FL server 10. Further, the FL server 10 aggregates the model gradients and updates the AI model. Further, in the (N+1)^{th} iteration, the FL process is repeated, and the AI model is further updated based on new model gradients.

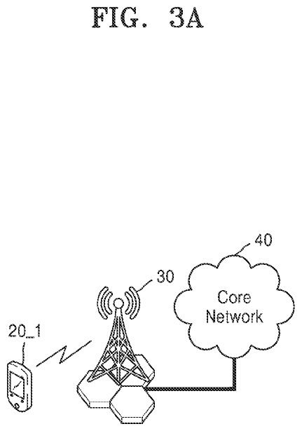

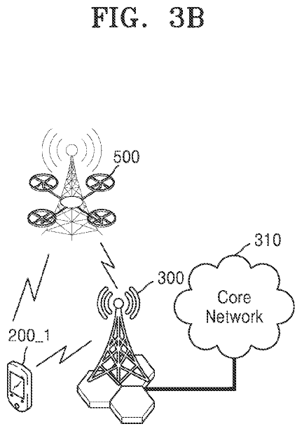

FIG. 3A illustrates an example scenario depicting the deployment of a terrestrial network in accordance with an existing state of the art. The terrestrial network includes a user equipment (UE) 20-1 that communicates with a core network 40 via a terrestrial cell 30. The availability of UE 20-1 in the terrestrial network for a Federated Learning (FL) process depends on the availability of the terrestrial network. Thus, for the FL process to be efficient in the terrestrial network, it is essential to improve the availability, capacity, and latency of the terrestrial network such that other UEs, which have better computing and storage features, can participate in the FL process.

Aerial platforms, such as unmanned aerial vehicles (UAVs) and high-altitude platforms (HAPs), have gained prominence for their ability to complement ground-based infrastructure by providing aerial connectivity and data offloading. However, efficiently integrating aerial platforms into communication networks and orchestrating their actions to enhance network performance remains challenging. Accordingly, the present disclosure describes a use of a Low-altitude Aerial Platform (LAP) based aerial cell in the terrestrial network to improve the efficiency of the FL process.

FIG. 3B illustrates an example scenario, according to an embodiment of the present disclosure, depicting a deployment of the terrestrial network, in which the LAP based aerial cell 500 assists the terrestrial network in improving network coverage, capacity, and latency. The terrestrial network as disclosed in FIG. 3B includes UE 200-1, core network 310, terrestrial cell 300, and LAP based aerial cell 500. The LAP based aerial cell 500 enables wireless network operators to expand the network coverage and capacity of the terrestrial network with lower capital expenditure (CAPEX) and moderate operational expenditure (OPEX), when compared to the additional resources (e.g., cost and time) spent on the construction and functioning of terrestrial network infrastructure such as macro cells and small cells. The aerial cell 500 can be strategically placed and moved to an optimal position in a three-dimensional (3D) space to provide connectivity services to the UE 200-1. The UE 200-1 can offer Dual Communication (DC) with the aerial cell 500 and the terrestrial cell 300.

The aerial cell 500 as the Non-Terrestrial Network (NTN) is an enabler for the beyond 5^{th} Generation (5G) and 6^{th} Generation (6G) networks, in which the aerial cell 500 is on board various types of aerial vehicles that can fly, navigate, and hover at various altitudes. The LAP based aerial cell 500 reduces the latency and increases the reliability of wireless communication.

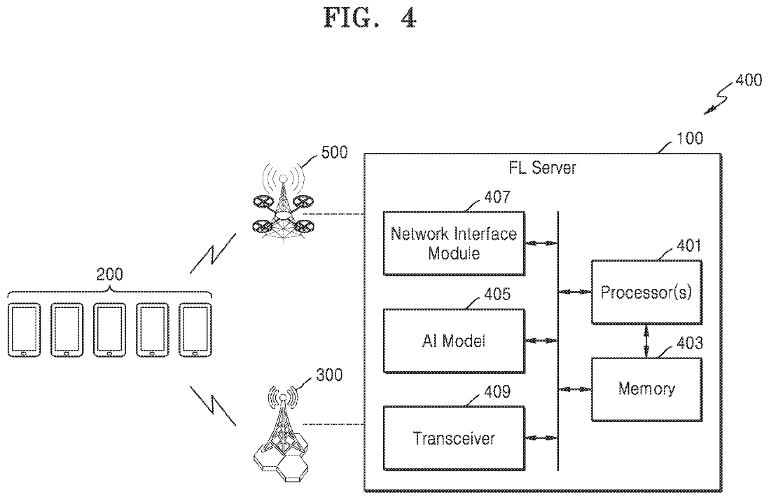

FIG. 4 illustrates a block diagram of a system 400 for aerial-assisted federated learning, according to one or more embodiments disclosed herein. The system 400 includes the aerial cell 500, the terrestrial cell 300, a federated learning (FL) server 100, and a plurality of user equipment (UEs) 200 communicatively coupled with the terrestrial cell 300 using a terrestrial link. The FL server 100 is connected with the terrestrial cell 300, the aerial cell 500, and the plurality of UEs 200. In some cases, the FL server 100 is connected with the terrestrial cell 300, the aerial cell 500, and the plurality of UEs 200 via a plurality of points of interface (Pols). For example, a PoI can include a point at which two or more communication networks interconnect.

The FL server 100 includes a processor 401, a memory 403, an AI model 405, a network interface module 407, and a transceiver 409.

The processor 401 can be a single processing unit or several units, all of which could include multiple computing units. The processor 401 may be implemented as one or more microprocessors, microcomputers, microcontrollers, digital signal processors, central processing units, state machines, logic circuitries, and/or any devices that manipulate signals based on operational instructions. Among other capabilities, the processor 401 is configured to fetch and execute computer-readable instructions and data stored in the memory 403.

The memory 403 includes one or more computer-readable storage media. The memory 403 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory may, in some examples, be considered a non-transitory storage medium. The term “non-transitory” may indicate that the storage medium is not embodied in a carrier wave or a propagated signal. However, the term “non-transitory” should not be interpreted to mean that the memory is non-movable. In certain examples, a non-transitory storage medium may store data that can, over time, change (e.g., in Random Access Memory (RAM) or cache.

The memory 403 may further include any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes.

The AI model 405 may be implemented with an AI module that may include a plurality of neural network layers. Examples of neural networks include but are not limited to, convolutional neural network (CNN), deep neural network (DNN), recurrent neural network (RNN), and Restricted Boltzmann Machine (RBM). The learning technique is a method for training a predetermined target device (for example, an electronic device) using a plurality of learning data to cause, allow, or control the electronic device to make a determination or prediction. Examples of learning techniques include but are not limited to supervised learning, unsupervised learning, semi-supervised learning, or reinforcement learning. At least one of a plurality of CNN, DNN, RNN, RBM models and the like may be implemented to thereby achieve execution of the present subject matter's mechanism through the AI model 405. A function associated with AI may be performed through the non-volatile memory, the volatile memory, and the processor 401.

According to some embodiments, AI model 405 comprises machine learning parameters stored in memory 403. Machine learning parameters, also known as model parameters or weights, are variables that provide a behavior and characteristics of a machine learning model. Machine learning parameters can be learned or estimated from training data and are used to make predictions or perform tasks based on learned patterns and relationships in the data.

Machine learning parameters are typically adjusted during a training process to minimize a loss function or maximize a performance metric. The goal of the training process is to find optimal values for the parameters that allow the machine learning model to make accurate predictions or perform well on the given task.

For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the machine learning parameters are used to make predictions on new, unseen data.

The CNN is a class of artificial neural network models (ANN) that is commonly used in computer vision or image classification systems. In some cases, the CNN may enable processing of digital images with minimal pre-processing. The CNN may be characterized by the use of convolutional (or cross-correlational) hidden layers. These layers apply a convolution operation to the input before signaling the result to the next layer. Each convolutional node may process data for a limited field of input (i.e., the receptive field). During a forward pass of the CNN, filters at each layer may be convolved across the input volume, computing the dot product between the filter and the input. During a training process, the filters may be modified so that they activate when they detect a particular feature within the input.

The DNN is a class of machine learning methods, which is based on artificial neural networks with representation learning. The adjective “deep” in deep learning refers to the use of multiple layers in the network. The DNN uses multiple layers to progressively extract higher-level features from the raw input. For example, in image processing, lower layers may identify edges, while higher layers may identify the concepts relevant to a human such as digits, letters or faces.

The recurrent neural network (RNN) is a class of ANN in which connections between nodes form a directed graph along an ordered (i.e., a temporal) sequence. This enables an RNN to model temporally dynamic behavior such as predicting what element should come next in a sequence. Thus, the RNN is suitable for tasks that involve ordered sequences such as text recognition (where words are ordered in a sentence). The term RNN may include finite impulse recurrent networks (characterized by nodes forming a directed acyclic graph), and infinite impulse recurrent networks (characterized by nodes forming a directed cyclic graph).

The supervised learning is one of three basic machine learning paradigms, alongside the unsupervised learning and the reinforcement learning. The supervised learning is a machine learning technique based on learning a function that maps an input to an output based on example input-output pairs. The supervised learning generates a function for predicting labeled data based on labeled training data consisting of a set of training examples. In some cases, each example is a pair consisting of an input object (typically a vector) and a desired output value (i.e., a single value, or an output vector). The supervised learning algorithm analyzes the training data and produces the inferred function, which can be used for mapping new examples. In some cases, the learning results in a function that correctly determines the class labels for unseen instances. In other words, the learning algorithm generalizes from the training data to unseen examples.

The unsupervised learning is also one of three basic machine learning paradigms, alongside the supervised learning and the reinforcement learning. The unsupervised learning draws inferences from datasets consisting of input data without labeled responses. The unsupervised learning may be used to find hidden patterns or grouping in data. For example, cluster analysis is a form of the unsupervised learning. Clusters may be identified using measures of similarity such as Euclidean or probabilistic distance.

The reinforcement learning is one of three basic machine learning paradigms, alongside the supervised learning and the unsupervised learning. Specifically, the reinforcement learning relates to how software agents make decisions in order to maximize a reward. The decision-making model may be referred to as a policy. This type of learning differs from the supervised learning in that labelled training data is not needed, and errors need not be explicitly corrected. Instead, the reinforcement learning balances exploration of unknown options and exploitation of existing knowledge. In some cases, the reinforcement learning environment is stated in the form of a Markov decision process (MDP). Furthermore, many reinforcement learning algorithms utilize dynamic programming techniques. However, one difference between the reinforcement learning and other dynamic programming methods is that the reinforcement learning does not require an exact mathematical model of the MDP. Therefore, reinforcement learning models may be used for large MDPs where exact methods are impractical.

The network interface module 407 may be an I/O interface. In some cases, the I/O interface is controlled by an I/O controller to manage input and output signals for computing device. In some cases, the I/O interface manages peripherals not integrated into the computing device. In some cases, the I/O interface represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via the I/O interface or via hardware components controlled by the I/O controller.

The network interface module 407 may connect to the communication network to enable connection of FL server 100 with the terrestrial cell 300 and the aerial cell 500. In some examples, the transceiver is configured to transmit (or send) and receive signals for a communications device via an antenna. The transceiver 409 may be implemented with the network interface module 407 to employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network may include, without limitation, a direct interconnection, local area network (LAN), wide area network (WAN), wireless network (e.g., using Wireless Application Protocol), the Internet, etc. The network interface may employ connection protocols including, but not limited to, direct connect, Ethernet (e.g., twisted pair 10/100/1000 Base T), transmission control protocol/internet protocol (TCP/IP), token ring, IEEE 802.11a/b/g/n/x, etc.

The memory 403 and the transceiver 409 may be coupled to the processor 401. The processor 401 may be configured to perform all the control functions of the FL server 100. The processor 401 may be configured to control the receiving or sending of the information or any control signal via the transceiver 409.

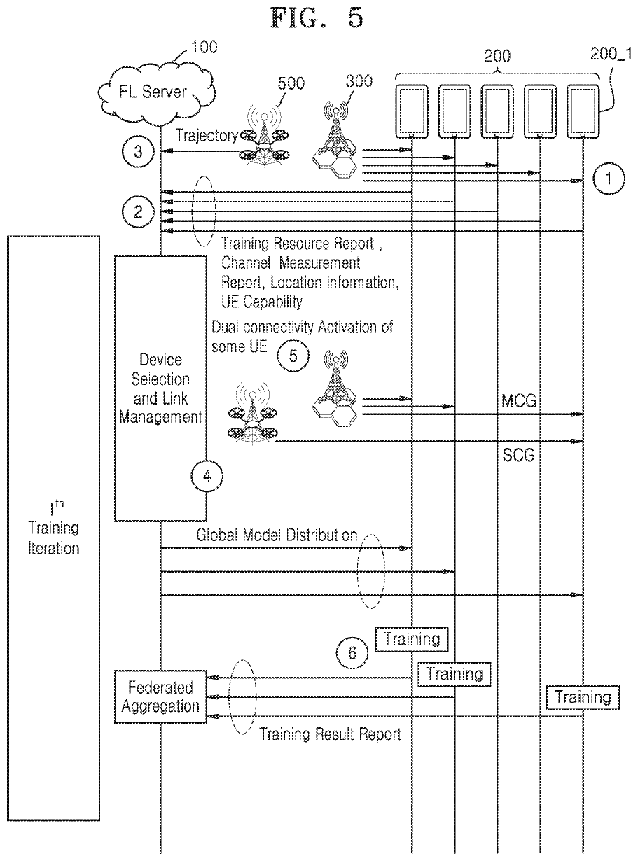

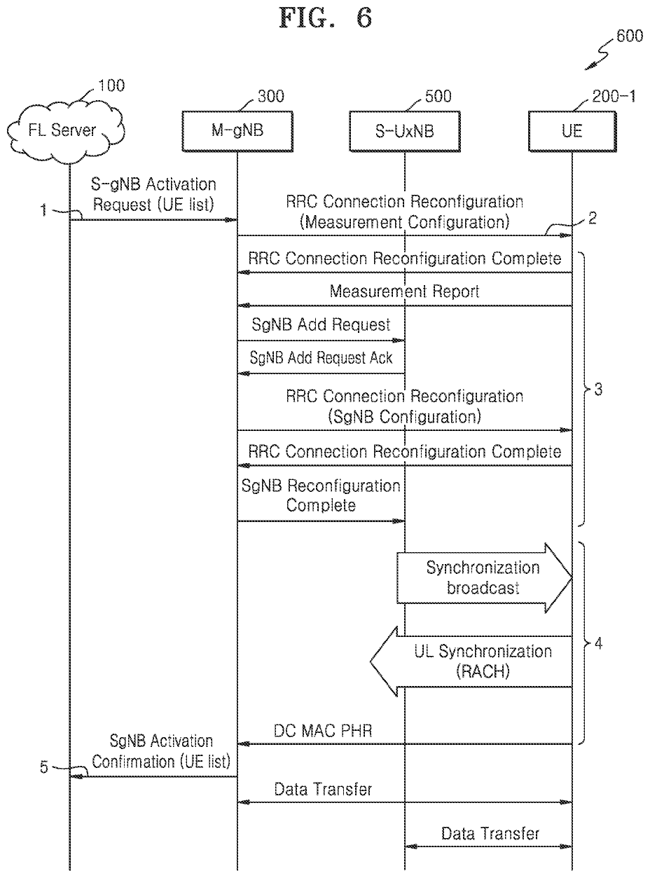

FIGS. 5 and 6 illustrate protocols and procedures for enhancing the FL process in a deployment where the UEs 200 offered DC with the aerial cell and the terrestrial cell. FIG. 5 illustrates a line diagram depicting a process flow for aerial-assisted federated learning, according to one or more embodiments disclosed herein. The process flow for the aerial-assisted federated learning or the process flow of the federated learning using an Aerial-Assisted protocol (FLAP) comprises a plurality of method steps 1 through 6.

In a first step (1), the plurality of UEs 200 served by the terrestrial cell 300 performs channel measurement. The plurality of UEs 200 receives measurement parameters from the terrestrial cell 300. Each UE of the plurality of UEs 200 measures a terrestrial link Channel Quality Indicator (CQI) corresponding to the UE. The terrestrial link CQI indicates a channel quality of the terrestrial link between the terrestrial cell 300 and the corresponding UE. In one or more embodiments, the terrestrial cell 300 is also referred to as M-gNB or a primary cell without any deviation from the scope of the present disclosure. The terrestrial cell 300 also offers Master Cell Group (MCG) to the plurality of UEs 200.

In 5G (fifth-generation) wireless communication systems, NR-MCG (New Radio Master Cell Group) pertains to the organization and management of cells within a cellular network. MCG represents a set of physical cell groups within a network that is primarily controlled and managed by a master gNodeB (gNB), ensuring efficient and coordinated operation. MCG serves as a higher-level organization that includes a set of secondary cell groups (SCGs) and allows for coordinated and efficient management of multiple cells. It helps optimize resources, perform inter-cell coordination, and manage control aspects that enhance overall network performance.

In a second step (2), the FL server 100 receives a plurality of parameter sets from the plurality of UEs 200. Each of the plurality of parameter sets includes the terrestrial link CQI of the corresponding UE, location information of the corresponding UE, and capability information of the corresponding UE to handle Dual Communication (DC) with an aerial link. Further, each plurality of the parameter sets further includes training resource information of the corresponding UE. The training resource information includes at least one of information associated with computation capability of the corresponding UE or information corresponding to training data at the corresponding UE.

In a third step (3), the FL server 100 receives from an aerial cell 500, trajectory information indicating a coverage range of the aerial cell 500. The aerial cell 500 may also be referred to as S-UxNB without any deviation from the scope of the present disclosure. The aerial cell 500 offers the Secondary Cell Group (SCG) to the plurality of UEs 200.

In a fourth step (4), the FL server 100 performs device selection during an I^{th} training iteration. In particular, the FL server 100 selects at least one UE 200-1 from the plurality of UEs 200 based on the received plurality of parameter sets and the received trajectory information. For selecting at least one UE 200-1 from the plurality of UEs 200, at first, the FL server 100 determines that the at least one UE 200-1 among the plurality of UEs 200 is in the coverage range of the aerial cell 500 based on the location information of the corresponding UE and the received trajectory information from the aerial cell 500. Thereafter, the FL server 100 selects at least one UE 200-1 when the terrestrial link CQI of the at least one UE 200-1 is lower than a threshold value, and the capability information of the at least one UE 200-1 indicates that the at least one UE 200-1 can handle the DC with the aerial link. Further, the FL server 100 selects at least one UE 200-1 in a case when the training resource information indicates that the computation capability of the at least one UE 200-1 is greater than a threshold capability.

In a fifth step (5), the FL server 100 performs, using the terrestrial cell 300, activation of DC for the at least one UE 200-1. For activating the DC, the FL server 100 triggers an activation of the aerial link between the aerial cell 500 and the selected at least one UE 200-1. Thereafter, the FL server 100 can select at least one UE 200-1 that may have the required training resources but an inferior terrestrial link. For such UE, the network initiates the aerial link from the aerial cell 500 to enable the DC. As shown in FIG. 5, for one of the UEs 200-1, the aerial link is established to include the at least one UE 200-1 in the federated UEs during an I^{th} iteration. Further details regarding the activation of DC to enable federated learning in beyond 5G Networks are provided with reference to FIG. 6.

In a sixth step (6), the selected federated UEs download a global model from the FL server 100, train the global model, and send the model gradients to the FL server 100. For instance, the federated UEs send to the FL server 100, the model gradients as a training result report. Thereafter, the FL server 100 aggregates the model gradients and updates the global model.

FIG. 6 illustrates a line diagram depicting a process flow 600 of activating Dual Communication (DC) to enable federated learning in beyond 5G Networks, according to one or more embodiments disclosed herein. The process flow 600 includes a plurality of operation steps 1 through 5.

As shown in FIG. 6, the process flow starts when the FL server 100 triggers the activation of the aerial link or the DC between the aerial cell 500 and the selected at least one UE 200-1. In a first operation step (1), the FL server 100 sends a list of the selected UEs to the terrestrial cell 300(M-gNB) for activating the aerial link with the aerial cell 500(S-UxNB) hosted on the LAP.

In a second operation step (2), the terrestrial cell 300 sends a measurement configuration including the cell information of the aerial cell 500 to the selected at least one UE 200-1. The terrestrial cell 300 sends the measurement configuration in an RRC connection reconfiguration message.

In a third operation step (3), the terrestrial cell 300 receives an RRC connection reconfiguration complete message from the selected at least one UE 200-1. The terrestrial cell 300 also receives a measurement report generated by the selected at least one UE 200-1. When a predefined criterion for link establishment is satisfied, the terrestrial cell 300 sends a request to the aerial cell 500 to provide the SCG. Next, the aerial cell 500 sends an acknowledgment to the terrestrial cell 300. Subsequently, the terrestrial cell 300 sends aerial cell configuration in an RRC connection reconfiguration message to the selected at least one UE 200-1. Thereafter, the selected at least one UE 200-1 sends an RRC connection reconfiguration complete message to the terrestrial cell 300. The terrestrial cell 300 then sends the aerial cell reconfiguration complete message to the aerial cell 500.

In a fourth operation step (4), after the aerial cell configuration is completed with the selected at least one UE 200-1, the selected at least one UE 200-1 performs downlink and uplink synchronization with the aerial cell 500 and reports Power Head Room (PHR) Medium Access Control (MAC) Control Element (CE) containing the report for both the terrestrial cell 300 and the aerial cell 500. The procedure for reporting PHR remains the same as in the DC with the terrestrial cell 300 and the aerial cell 500. At this point, the DC is activated.

In a fifth operation step (5), the terrestrial cell 300 sends a response to the FL server 100 indicating that the DC is activated for the selected at least one UE 200-1. Upon receiving the response, the FL server 100 adds the selected at least one UE 200-1 to a set of federated UEs for the FL process.

In the above disclosed aerial-assisted federated learning as shown in FIG. 5, there are four operation steps that are different from the classical FL protocol shown in FIG. 2. The aerial-assisted federated learning has a significant impact on the FL performance namely device selection, distribution of the global model, training at the federated UEs, and transfer of the updated model gradients from the federated UEs to the FL server 100. Embodiments disclosed herein model each of four operation steps and illustrate the improvement that can be extracted based on the aerial-assisted federated learning. The entire process for the above disclosed aerial-assisted federated learning is described below as shown in Procedure-1. Further, the definitions of the parameters used in each of the four operation steps are listed in Table 1.

Let there be Nᵢ devices (UEs) in the network that want to participate in the FL process in iteration i. Let FLAP_{DevSel}(Nᵢ) be the function (defined in Procedure-1) which controls the device selection (UE selection) in each iteration i. As the number of participating devices (UEs) increases, the performance of the FL is improved. The goal of the function FLAP_{DevSel} (Nᵢ) is to maximize the number of UE updates within the specified deadline (Step 21, of Procedure-1).

Procedure-1

| | |
|---|---|
| 1: | Input: |
| 2: | L_{I} = {L₁, L₂, ... . L_{R}}; LAP locations for each Training |
| | Iteration I |
| 3: | Z_{I} = {Z₁, Z₂, ... . Z_{R}}; Coverage zone on ground for each |
| | location in L_{I} |
| 4: | U_{I} = {UE₁, UE₂,.. UEₙ}; Set of UEs with apt training resource |
| | in each I. |
| 5: | Output: For each Iteration I,FedU_{I} = {UE₁,. UEₖ}; Set of |
| | Federated UEs |
| 6: | Begin FLAP_ITERATION |
| 7: | FedU_{I} = Ø |
| 8: | Sort Uⱼ in decending order of training resource |
| 9: | For each UE, UEⱼ in U |
| 10: | Get CQI, Location Loc, Capability A2G_{Link} from each UE |
| 11: | if CQI > CQIₜₕᵣₑₛₕ |
| 12: | FedU_{I} = FedU_{I} ∪ UEⱼ |
| 13: | End if |
| 14: | if A2G_{Link}, Loc ∈ Z_{I} |
| 15: | Trigger DC Establishment for activating s-UxNB for UE |
| 16: | if s-UxNB successfully established with LAP |
| 17: | FedU_{I} = FedU_{I} ∪ UEᵢ |
| 18: | End if |
| 19: | End if |
| 20: | End for |
| 21: | Optimize FedU_{I} |
| 22: | End FLAP ITERATION |

TABLE 1

| Parameter | Details |
|---|---|
| N | Number of UEs in network |
| FedUE^{Avl} | UE set available to take part in FL |
| FedUE^{Sel} | UE set selected to take part in FL with only |
| | terrestrial link |
| FedUE^{^{Sel}}^{DC} | UE set selected to take part in FL with DC link via |
| | aerial cell |
| Tᵢₜₑᵣ | Deadline for an iteration of FL |
| Tₘₐₓ | Final deadline for FL |
| T_{DS} | Time required for device selection |
| T_{Agg} | Time required for gradient aggregation at the FL |
| | Server |
| T^{^{D}}^{FLP}, T^{^{Ul}}^{FLP} | Time required for model distribution and gradient |
| | upload over terrestrial-only link, respectively |
| T^{^{D}}^{FALP}, Tₙ_{ₖ}^{^{Ul}}^{FLAP} | Time required for model distribution and gradient |
| | upload over DC via aerial cell, respectively |
| T^{Upd} | Time required for updating the model at a device |
| T^{DC} | Time required for activating the aerial-assisted DC |
| | link |

Let FedUEᵢ^{Avl}={1, . . . , Nᵢ} be the set of indices that describes the available Nᵢ devices (UEs) in iteration i. Let FedUEᵢ^{Avl}=[n₁, n₂, . . . , n_{|FedUEiSel|}] describe the sequence of indices of the devices (UEs) with only terrestrial link, where nᵢ∈N and |FedUEᵢ^{Avl}|≥|FedUEᵢ^{Sel}|. Let the sequence of indices of the devices (UEs) for which the aerial link is required, be given by FedUEᵢ^{SelDC}=[nₐ₁, nₐ₂, . . . , n_{|FedUEiSelDC|}], where nₐᵢ∈Nᵢ, and |FedUEᵢ^{Avl}|≥|FedUEᵢ^{Sel}|+|FedUEᵢ^{SelDC}|.

Let Tᵢₜₑᵣ be the deadline for every iteration of FL and Tₘₐₓ be the final deadline for FL. T_{DS} and T_{Agg} are the time required for device selection (UE selection) and gradient aggregation at the FL Server, respectively. Tₙₖ^{DFLP} and Tₙₖ^{DFLAP} are the time required for model distribution over terrestrial-only link and the DC with the aerial link for a device (UE) with index Ilk, respectively; in general, Tₙₖ^{DFLAP}<Tₙₖ^{DFLP}. Tₙₖ^{Upd} is the time required for updating the model at the device (UE) with index nk, depending on the device capability (UE capability). Tₙₖ^{UIFLP} and Tₙₖ^{UIFLAP} are the time required for upload of the gradients over terrestrial-only link and the DC with aerial link, respectively, at the device (UE) with index nk; in general, Tₙₖ^{UIFLP}<Tₙₖ^{UIFLAP}. T^{DC} is the time required for activating the aerial link for any device (UE).

Given that there are enough available physical channel resources on a communication link (i.e., the terrestrial link or DC with the aerial link) for the selected devices (UEs), the model download, update, and upload can happen in parallel on each of the devices (UEs), given by Eq. (1), δₙₖ^{FLP} and Eq. (2), δₙₖ^{FLAP} respectively for the terrestrial link and the DC with the aerial link. δₘₐₓ^{FLP} and δₘₐₓ^{FLAP} are the maximum time across all devices (UEs), given by Eq. (3) and Eq. (4), respectively.

∀nₖ∈FedUEᵢ^{Sel};∂ₙ_{ₖ}^{FLP}=Tₙ_{ₖ}^{D}^{_{FLP}}+Tₙ_{ₖ}^{Upd}+Tₙ_{ₖ}^{UI}^{_{FLP}} (1)

∀nₖ∈FedUEᵢ^{Sel}^{_{DC}};∂ₙ_{ₖ}^{FLAP}=T^{DC}+Tₙ_{ₖ}^{D}^{_{FLAP}}+Tₙ_{ₖ}^{Upd}+Tₙ_{ₖ}^{UI}^{_{FLAP}} (2)

∂ₘₐₓ^{FLP}=max(∂ₙ_{₁}^{FLP}, . . . ,∂_{|FedUE}_{ᵢ}_{^{Sel|}}^{FLP}) (3)

∂ₘₐₓ^{FLAP}=max(∂ₙ_{₁}^{FLAP}, . . . ,∂_{|FedUE}_{ᵢ}_{^{Sel}}_{DC|}^{FLAP}) (4)

The function FLAP_{DevSel}(Nᵢ) is formulated using the maximization problem (5), where, there are three constraints. The first constraint states that the total time taken for the device selection (i.e., UE selection), gradient aggregation, and device (UE) specific time for download, update, and upload across all selected devices (UEs) should be less than the deadline for each iteration. The second constraint captures the condition that the total upload size from all selected devices (UEs with only the terrestrial link) should be less than the maximum system bandwidth of the terrestrial link. The third constraint captures the condition that the total upload size from all selected devices (UEs with aerial link) should be less than the maximum system bandwidth of the DC with the aerial link. The global model download can be performed in a multicast broadcast mode, such that it does not feature in the constraints. In (5), UP_{size} defines the size in bytes for the model update from each device (UE). TP_{TL} is the system throughput in bytes per second for the terrestrial link. TP_{DC} is the system throughput in bytes per second for the DC with the aerial link.

max|FedUEᵢ^{Sel}|,max|FedUEᵢ^{Sel}^{_{DC}}|

s.t.T_{DS}+T_{Agg}+max(∂ₘₐₓ^{FLP},∂ₘₐₓ^{FLAP})≤Tᵢₜₑᵣ

s.t.|FedUEᵢ^{Sel}|×UP_{size}≤TP_{TL}×Tᵢₜₑᵣ

s.t.|FedUEᵢ^{Sel}^{_{DC}}|×UP_{size}≤TP_{DC}×Tᵢₜₑᵣ (5)

The critical parameter Tᵢₜₑᵣ controls the number of iterations that can be scheduled within the final deadline Tmax, and can affect the FL performance, if the aggregation does not meet the desired performance metric of the trained model (e.g., accuracy of detection or classification). Thus, as the value of Tᵢₜₑᵣ reduces, few devices (UEs) (bound by max|FedUEᵢ^{Sel}| in (5)) with lower update and upload times are selected in the classical FL, to keep a low value of δₘₐₓ^{FLP}. By contrast, as Tₙₖ^{UIFLAP} and Tₙₖ^{DFLAP} are reduced, a high number of devices (UEs) with the aerial link (bound by max|FedUEᵢ^{SelDC}| in (5)) are selected due to the proposed FLAP. Accordingly, the performance of aerial-assisted FL is improved in comparison to classical FL. In the absence of FLAP, the devices (UEs) may be neglected and dropped due to poor CQI with the terrestrial link. In case of the classical FL over the terrestrial network, the device selection (UE selection) is formulated by the maximization problem given by (6). The UEs with the aerial link are not available in the selected set and the two constraints are formulated in a similar manner as (5), albeit limited to the terrestrial link.

max|FedUEᵢ^{Sel}|

s.t.T_{DS}+T_{Agg}+∂ₘₐₓ^{FLP}≤Tᵢₜₑᵣ

s.t.|FedUEᵢ^{Sel}|×UP_{size}≤TPₜ×Tᵢₜₑᵣ (6)

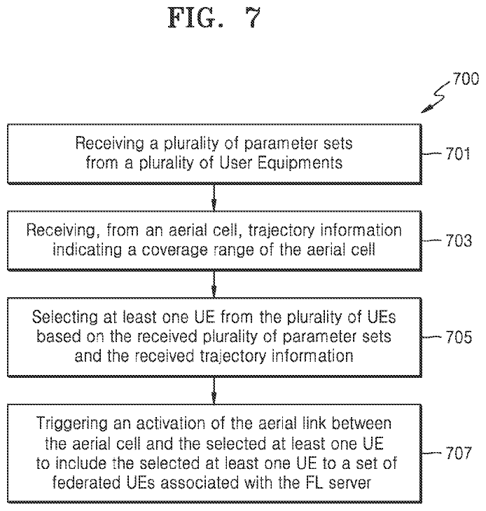

FIG. 7 illustrates a flow diagram depicting a method 700 for aerial-assisted federated learning at the FL server 100, according to one or more embodiments disclosed herein. The method 700 includes a series of steps 701 through 707.

At the step 701, the transceiver 409 of the FL server 100 (as described with reference to FIG. 4) receives a plurality of parameter sets from a plurality of UEs 200. Each of the plurality of parameter sets includes the terrestrial link CQI of the corresponding UE, location information of the corresponding UE, and capability information of the corresponding UE to handle Dual Communication (DC) with the aerial link. Additionally, each of the plurality of parameter sets may include training resource information of the corresponding UE. The training resource information includes at least one of an information of a computation capability of the corresponding UE or information on training data at the corresponding UE.

At the step 703, the transceiver 409 of the FL server 100 receives, from the aerial cell 500, trajectory information indicating the coverage range of the aerial cell 500.

At the step 705, the processor 401 of the FL server 100 (as described with reference to FIG. 4) selects at least one UE 200-1 from the plurality of UEs 200 based on the received plurality of parameter sets and the received trajectory information. The processor 401 selects the at least one UE 200-1 to include the at least one UE 200-1 in a list of the federated UEs. The processor 401 may select the at least one UE 200-1 that may have the required training resources but an inferior terrestrial link. For example, the processor 401 may select the at least one UE 200-1 when the terrestrial link CQI of the at least one UE 200-1 is lower than the threshold value and the training resource information indicates that the computation capability of the at least one UE 200-1 is greater than the threshold capability.

At the step 707, the processor 401 triggers an activation of the aerial link between the aerial cell 500 and the selected at least one UE 200-1 to include the selected at least one UE 200-1 to the set of federated UEs associated with the FL server 100. The processor 401 may control the transceiver 409 to send the list of the selected at least one UE 200-1 to the terrestrial cell 300 for activating the aerial link with the aerial cell 500. The terrestrial cell 300 shares the aerial cell configuration with the at least one UE 200-1 for activating the DC. When the DC is activated for the selected at least one UE 200-1, the terrestrial cell 300 informs the FL server 100 that the DC is activated for the selected at least one UE 200-1. Thereafter, the processor 401 of the FL server 100 adds the selected at least one UE 200-1 to the set of federated UEs for the FL process. Further details regarding the activation of the aerial link have been provided with reference to FIG. 6.

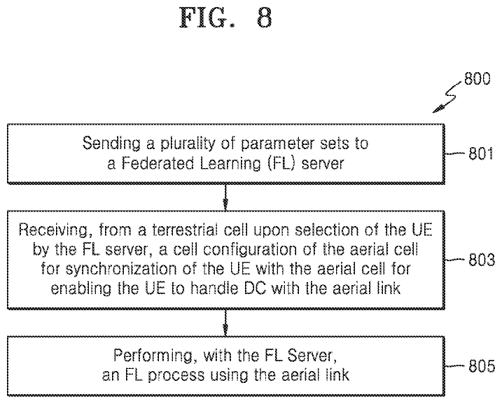

FIG. 8 illustrates a flow diagram depicting a method 800 for aerial-assisted federated learning at a UE among the plurality of UEs, according to one or more embodiments disclosed herein. The method 800 includes a series of steps 801 through 805.

At the step 801, the UE sends a plurality of parameter sets to the FL server 100. The plurality of parameter sets includes a terrestrial link CQI of the UE, capability information of the UE to handle DC with the aerial link, and location information of the UE. The plurality of parameter sets further includes training resource information of the UE. The training resource information includes at least one of information of computation capability of the UE or information of training data at the UE. The FL server 100 may select the UE for the DC with the aerial link in a case when the terrestrial link CQI of the UE is lower than the threshold value and the capability information indicates that the UE can handle the DC with the aerial link. Further, the FL server 100 may select the UE in a case when the training resource information indicates that the computation capability of the UE is greater than the threshold capability.

At the step 803, the selected UE receives, from the terrestrial cell 300, a cell configuration of the aerial cell 500 for synchronization of the UE with the aerial cell 500 for enabling the UE to handle DC with the aerial link.

At the step 805, after synchronization of the UE with the aerial cell 500, the UE performs the FL process using the aerial link. For example, the UE downloads the global model from the FL server 100, trains the global model, and sends model gradients as the training result report to the FL server 100 as part of performing the FL process.

Now, referring to the technical effect and abilities of the present disclosure, the above disclosed method provides various advantages including improving the wireless link between the UE and the FL server with reduced latency and improved reliability. Additionally, the method increases the number of federated UEs in the FL process.

Unless otherwise defined, all technical and scientific terms used herein have the same meaning as commonly understood by one ordinary skilled in the art to which this invention belongs. The system, methods, and examples provided herein are illustrative only and not intended to be limiting.

While specific language has been used to describe the present subject matter, any limitations arising on account thereto, are not intended. As would be apparent to a person in the art, various working modifications may be made to the method to implement the inventive concept as taught herein. The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment.

The embodiments disclosed herein can be implemented using at least one hardware device and performing network management functions to control the elements.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein. It will be understood that various changes in form and details may be made therein without departing from the spirit and scope of the following claims.

We claim:

1. A method for aerial-assisted federated learning at a Federated Learning (FL) server comprising:
receiving, from a plurality of User Equipment (UEs), a plurality of parameter sets, respectively, wherein each of the plurality of parameter sets includes a terrestrial link Channel Quality Indicator (CQI), location information, and capability information of a corresponding UE to handle Dual Communication (DC) with an aerial link;
receiving, from an aerial cell, trajectory information indicating a coverage range of the aerial cell;
selecting at least one UE from the plurality of UEs based on the received plurality of parameter sets and the received trajectory information; and
triggering an activation of the aerial link between the aerial cell and the selected at least one UE to include the selected at least one UE to a set of federated UEs associated with the FL server.

2. The method of claim 1, wherein:
the terrestrial link CQI is measured by the corresponding UE based on measurement parameters received from a primary cell, and
the terrestrial link CQI indicates a channel quality of the terrestrial link between the primary cell and the corresponding UE.

3. The method of claim 1, wherein selecting the at least one UE from the plurality of UEs comprises:
determining, based on the location information of the corresponding UE and the received trajectory information, that the at least one UE among the plurality of UEs is in the coverage range of the aerial cell; and
selecting the at least one UE from the plurality of UEs wherein:
the terrestrial link CQI of the at least one UE is lower than a threshold value; and
the capability information indicates that the at least one UE can handle the DC with the aerial link.

4. The method of claim 3, wherein:
each of the plurality of parameter sets includes training resource information of the corresponding UE, and
the training resource information includes at least one of information of computation capability of the corresponding UE or information of training data at the corresponding UE.

5. The method of claim 4, wherein selecting the at least one UE from the plurality of UEs, further comprises:
selecting the at least one UE from the plurality of UEs when the training resource information indicates that the computation capability of the at least one UE is greater than a threshold capability.

6. The method of claim 1, wherein triggering the activation of the aerial link comprises:
sending the selected at least one UE to a primary cell for activating the aerial link with the aerial cell hosted on a Low Altitude Platform (LAP).

7. The method of claim 6 further comprising:
receiving, from the primary cell, a response indicating that the DC is activated for the selected at least one UE; and
adding, upon receiving the response, the selected at least one UE to the set of federated UEs for an FL process.

8. The method of claim 7 further comprising:
performing with the selected at least one UE the FL process using the aerial link.

9. The method of claim 8, wherein performing the FL process comprises:
sending a global model distribution to the selected at least one UE;
performing, by the selected at least one UE, a machine learning training process based on the global model distribution; and
receiving a training result report from the selected at least one UE based on the machine learning training process.

10. A federated learning (FL) server, comprising:
one or more processors and a transceiver;
wherein the one or more processors and the transceiver are configured to:
receive, from a plurality of User Equipment (UEs), a plurality of parameter sets, respectively, wherein each of the plurality of parameter sets includes a terrestrial link Channel Quality Indicator (CQI), location information, and capability information of a corresponding UE to handle Dual Communication (DC) with an aerial link;
receive, from an aerial cell, trajectory information indicating a coverage range of the aerial cell;
select at least one UE from the plurality of UEs based on the received plurality of parameter sets and the received trajectory information; and
trigger an activation of the aerial link between the aerial cell and the selected at least one UE to include the selected at least one UE to a set of federated UEs associated with the FL server.

11. The FL server of claim 10, wherein the one or more processors are further configured to:
determine, based on the location information of the corresponding UE and the received trajectory information, that the at least one UE among the plurality of UEs is in the coverage range of the aerial cell; and
select the at least one UE from the plurality of UEs wherein:
the terrestrial link CQI of the at least one UE is lower than a threshold value; and
the capability information indicates that the at least one UE can handle the DC with the aerial link.

12. The FL server of claim 11, wherein:
each of the plurality of parameter sets includes training resource information of the corresponding UE, and
the training resource information includes at least one of information of computation capability of the corresponding UE or information of training data at the corresponding UE.

13. The FL server of claim 12, wherein the one or more processors are further configured to:
select at least one UE from the plurality of UEs when the training resource information indicates that the computation capability of the at least one UE is greater than a threshold capability.

14. The FL server of claim 10, wherein the one or more processors are further configured to:
send the selected at least one UE to a primary cell for activating the aerial link with the aerial cell hosted on a Low Altitude Platform (LAP).

15. The FL server of claim 14, wherein the one or more processors are further configured to:
receive, from the primary cell, a response indicating that the DC is activated for the selected at least one UE; and
add, upon receiving the response, the selected at least one UE to the set of federated UEs for an FL process.

16. A method for aerial-assisted federated learning at a User Equipment (UE) comprising:
sending, to a Federated Learning (FL) server, a plurality of parameter sets, respectively, wherein the plurality of parameter sets includes a terrestrial link Channel Quality Indicator (CQI), capability information of the UE to handle Dual Communication (DC) with an aerial link, and location information,
wherein the FL server selects the UE for the DC with the aerial link when the terrestrial link CQI of the UE is lower than a threshold value and the capability information indicates that the UE can handle the DC with the aerial link;
receiving, from a primary cell upon selection of the UE by the FL server, a cell configuration of the aerial cell for synchronization of the UE with the aerial cell for enabling the UE to handle DC with the aerial link; and
performing, with the FL Server, an FL process using the aerial link.

17. The method of claim 16, wherein
the plurality of parameter sets includes training resource information of the UE, and
the training resource information includes at least one of information of computation capability of the UE or information of training data at the UE.

18. The method of claim 17, wherein:
the FL server selects the UE for the DC with the aerial link when the training resource information indicates that the computation capability of the UE is greater than a threshold capability.

19. The method of claim 16, wherein performing the FL process comprises:
receiving a global model distribution;
performing a machine learning training process based on the global model distribution; and
transmitting a training result report to the FL server based on the machine learning training process.

20. The method of claim 16, wherein:
the terrestrial link CQI is measured by the UE based on measurement parameters received from the primary cell, and
the terrestrial link CQI indicates a channel quality of the terrestrial link between the primary cell and the UE.
